(19) United States
(12) Patent Application Publication
(10) Pub. No.: US 2006/0235614 A1
(43) Pub. Date: Oct. 19, 2006

(54) Method and Apparatus for Automatic Identification of Celestial Bodies

(75) Inventors: Michael Jacox, College Station, TX (US); James Ochoa, Bryan, TX (US); John Zbranek, College Station, TX (US); Brian Wood, College Station, TX (US); Anup Katake, College Station, TX (US); Christian Bruccoleri, College Station, TX (US)

Correspondence Address: BAKER BOTTS L.L.P., 2001 ROSS AVENUE, SUITE 600, DALLAS, TX, 75201-2980, US

(73) Assignee: StarVision Technologies Inc.

(21) Appl. No.: 11/279,668

(22) Filed: Apr. 13, 2006

Related U.S. Application Data
(60) Provisional application No. 60/671,970, filed on Apr. 14, 2005.

(51) Int. Cl. G01C 21/00

(52) U.S. Cl. 701/222; 701/226

(57) ABSTRACT

According to one embodiment of the present invention, an apparatus for automatic identification of celestial bodies comprises an imager and logic encoded in media. The imager is operable to accept incoming light from celestial bodies and produce a digital image. The logic encoded in media is operable to identify centroids of the celestial bodies within the digital image, and identify the celestial bodies by comparing angles derived from the centroids with catalogued values. The imager and the logic encoded in media are contained in a first enclosure. The first enclosure is sized to be held in a hand of a user or in a telescope mount.

### RELATED APPLICATIONS

Pursuant to 35 U.S.C. § 119 (e), this application claims priority to U.S. Provisional Patent Application Ser. No. 60/671,970, entitled METHOD AND APPARATUS FOR AUTOMATIC IDENTIFICATION OF STARS, filed Apr. 14, 2005. U.S. Provisional Patent Application Ser. No. 60/671,970 is hereby incorporated by reference.

### TECHNICAL FIELD OF THE INVENTION

This invention relates in general to stars and, more particularly, to a method and apparatus for automatic identification of celestial bodies.

### BACKGROUND OF THE INVENTION

Star trackers have generally been used on satellites for nearly 40 years to identify stars and compute the attitude of the spacecraft. Telescopes now have automated mounts that are controlled by computer to point to any given celestial object.

### SUMMARY OF THE INVENTION

According to one embodiment of the present invention, an apparatus for automatic identification of celestial bodies comprises an imager and logic encoded in media. The imager is operable to accept incoming light from celestial bodies and produce a digital image. The logic encoded in media is operable to identify centroids of the celestial bodies within the digital image, and identify the celestial bodies by comparing angles derived from the centroids with catalogued values. The imager and the logic encoded in media are contained in a first enclosure, and the first enclosure is sized to be held in a hand of a user or in a telescope mount.

Certain embodiments may provide a number of technical advantages. For example, a technical advantage of one embodiment may include the capability to identify, in a handheld device, the name of targeted celestial bodies and present the names of such celestial bodes to an operator or user. Other technical advantages of other embodiments may include the capability to calibrate a camera used to obtain a digital image. Yet further technical advantages of other embodiments may include the capability to determine, from a hand-held device, three-dimensional vectors to pairs of celestial bodies to determine an identification of a celestial body. Still yet further technical advantages of other embodiments may include the capability to determine and remove a local background from a digital image for the identification of celestial bodies. Still yet further technical advantages of other embodiments may include the capability to efficiently determine a centroid for a celestial body.

Although specific advantages have been enumerated above, various embodiments may include all, some, or none of the enumerated advantages. Additionally, other technical advantages may become readily apparent to one of ordinary skill in the art after review of the following figures, description, and claims.

### BRIEF DESCRIPTION OF THE DRAWINGS

To provide a more complete understanding of the embodiments of the invention and features and advantages thereof, reference is made to the following description, taken in conjunction with the accompanying figures, wherein like reference numerals represent like parts, in which:

FIG. 1 depicts an exploded view of an apparatus for identifying celestial bodies, according to an embodiment of the invention;

FIG. 2 depicts logic architecture operable to identify a targeted celestial body, according to an embodiment of the invention;

FIG. 3 depicts an electronic assembly, according to an embodiment of the invention;

FIG. 4 illustrates a method of identifying celestial bodies using inter-celestial body angles, according to an embodiment of the invention;

FIG. 5 schematically illustrates an identification of celestial bodies, according to an embodiment of the invention;

FIG. 6 illustrates a method of calibrating an apparatus for identifying celestial bodies, according to an embodiment of the invention;

FIG. 7 illustrates a method of estimating a local threshold for centroid determination, according to an embodiment of the invention; and

FIG. 8 illustrates a method of estimating a centroid according to an embodiment of the invention.

### DETAILED DESCRIPTION OF EXAMPLE EMBODIMENTS

It should be understood at the outset that although example implementations of embodiments of the invention are illustrated below, embodiments of present invention may be implemented using any number of techniques, whether currently known or in existence. The present invention should in no way be limited to the example implementations, drawings, and techniques illustrated below. Additionally, the drawings are not necessarily drawn to scale.

In the space environment, recent improvements in star pattern identification and digital imaging have made it possible to determine spacecraft orientation from star identification without prior knowledge of the attitude. However, the precision required for spacecraft attitude knowledge also requires expensive optics and careful manufacturing. The space environment also requires instruments such as star trackers to be radiation tolerant, mechanically robust to survive launch vibrations and capable of withstanding extreme temperature cycles.

Star trackers used on satellites use digital images of several stars to determine their unique pointing vector but do not specifically target or identify a specific star.

Automated telescopes require users to set up a stand that is level in latitude and longitude and initially point to the north star. Once set-up, the telescope can then be guided autonomously to any given star if it has the correct date and location information.

However, many users are uncomfortable with the set-up requirements and some are even unable to locate the north star because of obstructions.

Accordingly, teachings of certain embodiments of the invention recognize a device and method that does not require date or location knowledge and does not provide the operator with an attitude. Embodiments of the invention use a pointing device to identify a star that is targeted by the user.

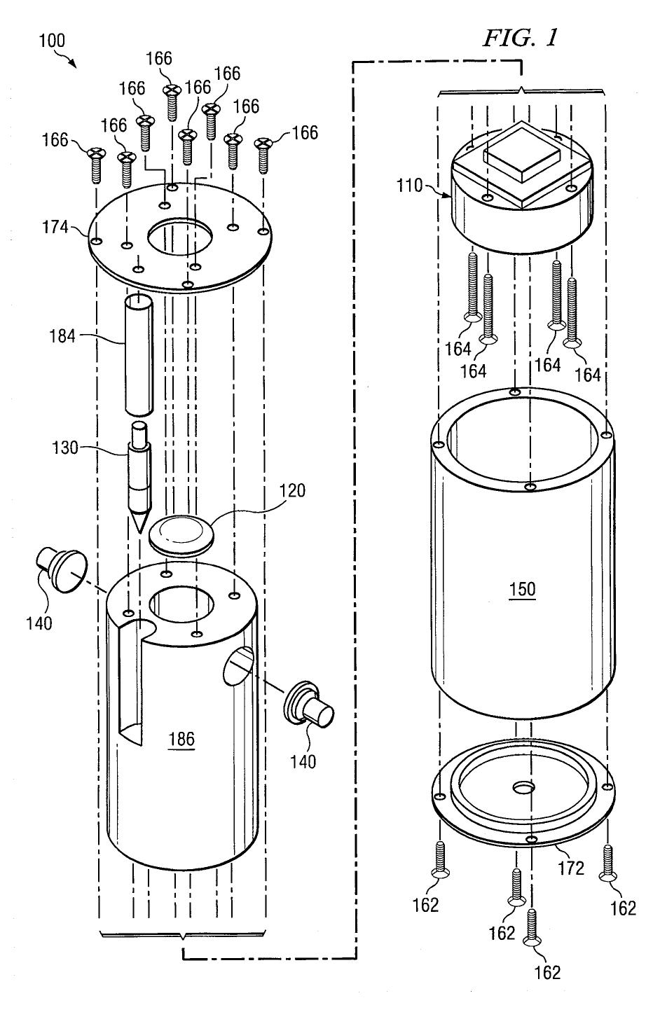

The embodiments depicted by FIGS. 1-8 generally represent an apparatus and method for identification of celestial bodies such as stars. Although examples with stars are identified in some embodiments, it should be expressly understood that the embodiments of the invention may be utilized to identify other types of celestial bodies, including, but not limited to, planets and comets. In some embodiments, the apparatus and method may be incorporated into a handheld device, allowing identification of celestial bodies targeted by a user. Additionally, in some embodiments the apparatus and method may be operated anywhere on Earth with a view of the night sky.

FIG. 1 depicts an exploded view of an apparatus 100 for identifying celestial bodies, according to an embodiment of the invention. The apparatus 100 of FIG. 1 in this embodiment includes an imager or digital imager 110, a lens 120, a pointing device 130, switches 140, and a housing 150. The imager or digital imager 110 may generally be any device and/or devices capable of accepting incoming focused light and producing corresponding electrons (e.g., to produce a digital image). In particular embodiments, imager or digital imager 110 may be a charged coupled device (CCD) or complementary metal oxide semiconductor (CMOS). In other embodiments, the imager or digital imager 110 may additionally be other suitable devices.

The lens 120 may generally focus light from an infinite source such as light from a celestial body onto an area of several pixels on the digital imager 110. The lens 120 may be made of several individual elements or a single element. Associated with the lens 120 in particular embodiments may be components that facilitate a movement of the lens to allow for focusing.

The pointing device 130 may generally be any device capable of facilitating an alignment of the apparatus 100 with a celestial body or bodies such that the celestial body falls in a field of view of the lens 120 and imager or digital imager 110. In particular embodiment, the pointing device 130 may be a green laser because of the sensitivity of the human eye to green. In other embodiments, the pointing device 130 may be other types of lasers. In yet further embodiments, the pointing device may be a user interface screen or viewer through which a user may view celestial bodies. In yet further embodiments, more than one type of pointing device may be utilized.

A switch 140 may be utilized as a switch for the laser power. A switch 140 may also be used for controlling capture of a digital image. For example, the imager or digital imager 140 may be controlled with an electronic shutter to allow sufficient light to be captured. In embodiments in which the pointing device 130 is a user interface screen or viewer, users may push the switch 140 in a manner similar to taking a picture.

The housing 150 in FIG. 1 is operable to house several component parts of the apparatus 100. In the embodiment of FIG. 1, the remaining components parts are disposed within the housing, facilitating the ability to hold the apparatus 100 in the palm of a hand. The housing may have a variety of different shapes. For example, the housing may be a tubular shape as shown in FIG. 1 - a form that is simple to machine. Yet other shapes and production techniques (e.g., injection molding) may be utilized.

Although not explicitly shown in FIG. 1, the apparatus 100 may additionally include a variety of other components, some of which will be described in greater detail below with reference to other figures. As an example, the apparatus may include a user interface screen (e.g., LCD screen or the like), memory, and communication components. The user interface screen may display, among other items, information on the identification of celestial bodies. The memory may be any suitable memory, which contains software for the identification of the celestial body. The communication components may be any suitable communication device used to communicate with devices external to the apparatus. Example communication components include, but are not limited to wireless devices (e.g., for wireless communications) and wired devices. Wired devices include, but are not limited to, USB or Firewire or similar communication interfaces. Wireless devices may conform to any suitable standard including, but not limited to 802.11x, 802.16x, Bluetooth, ZigBee and others (including those used with standard mobile phones). Further details of these and other components will be described with reference to the figures below. In various embodiments, some or all of these additional components may be housed within the housing 150.

Other salient features of the apparatus 100 of FIG. 1 may include couplers 162, 164, and 166; end caps 172 and 174; and inside laser housing 184 and outside laser housing 186. The couplers 162, 164, and 166 facilitate a coupling of select component parts of the apparatus 100 together. In particular embodiments, the couplers 162, 164, and 166 may be screws, fasteners, or the like. In other embodiments, the couplers 162, 164, and 166 may be glue or epoxy.

In particular embodiments, the apparatus 100 may be a standalone device, a device which communicates with other devices, and/or a device integrated with other devices. For example, in particular embodiments, the apparatus 100 may be integrated with a digital camera, a mobile phone with a camera, or a PDA with a camera. In such embodiments, certain components of the apparatus 100 may be components already utilized by the device with which the apparatus 100 is integrated (e.g., digital cameras already having CCD imagers). Additionally, in certain embodiments, the digital image may be either processed on-board or transmitted to a remote device for processing. For example, in embodiments in which the apparatus is integrated with a mobile phone, the mobile phone may take a digital image of the night sky, transmit the digital image (using any of variety of transmission protocols) to a remote device for processing. Then, after processing the digital image, the remote device may return information on the identification of the celestial bodies identified in the original digital photo. To enhance the processing of such digital images, any of a variety of information may be transmitted along with the digital image, including, but not limited to time/date stamps.

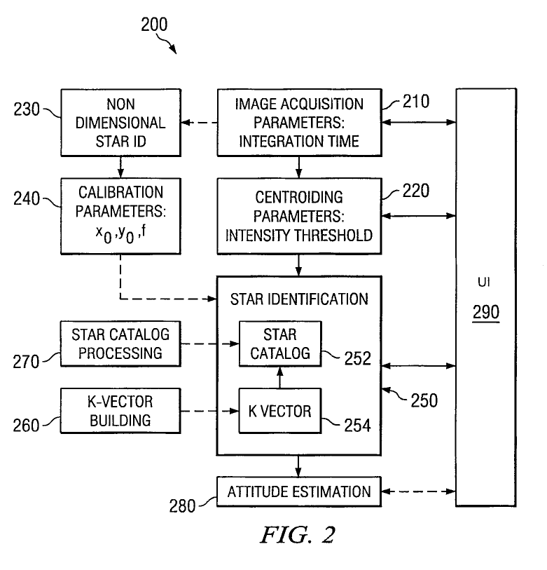

FIG. 2 depicts logic architecture 200 operable to identify a targeted celestial body, according to an embodiment of the invention. The logic architecture 200, for example, may be utilized in conjunction with the apparatus 100 of FIG. 1. The logic architecture 200 may utilize logic in hardware, software, or a combination of hardware and software.

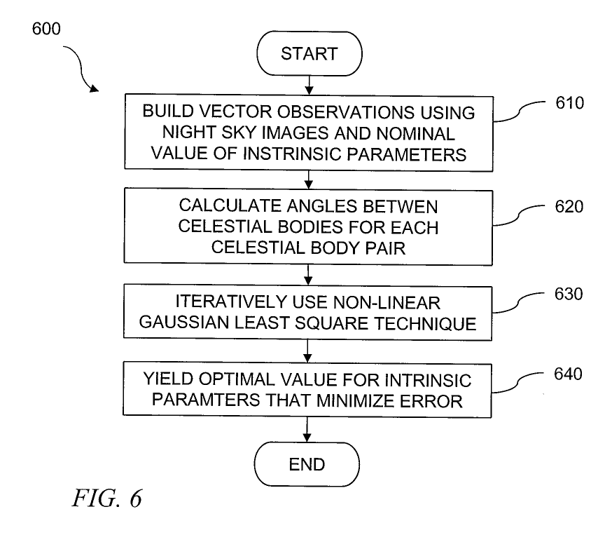

The logic architecture 200 of FIG. 2 may include a variety of processing blocks. For example, the logic architecture 200 may include an Image Acquisition block 210, which acquires the digital image (e.g., from the imager or digital imager 100). The image acquisition process in the Image Acquisition block 210 may be tailored for the optimum signal to noise ratio, for example, considering the handheld nature of the apparatus 100 in some embodiments. Once an image is captured, an initial calibration may be conducted by sending the centroid data to the Non-Dimensional Star ID block 230, which may compute the correct camera parameters and send the updated camera parameters to the Calibration block 240. The Calibration block 240, in turn, may update the centroid data before sending each star centroid to a Star Identification block 250, described in further details below. Further details of calibration are provided below with reference to FIG. 6.

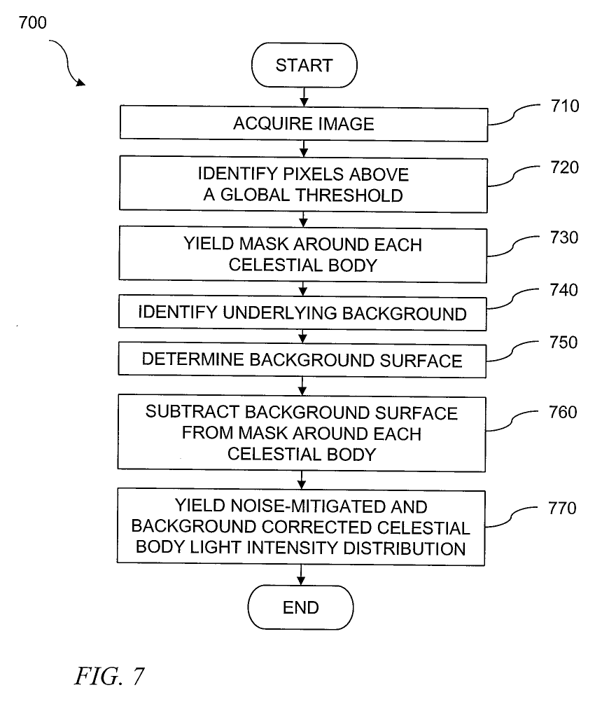

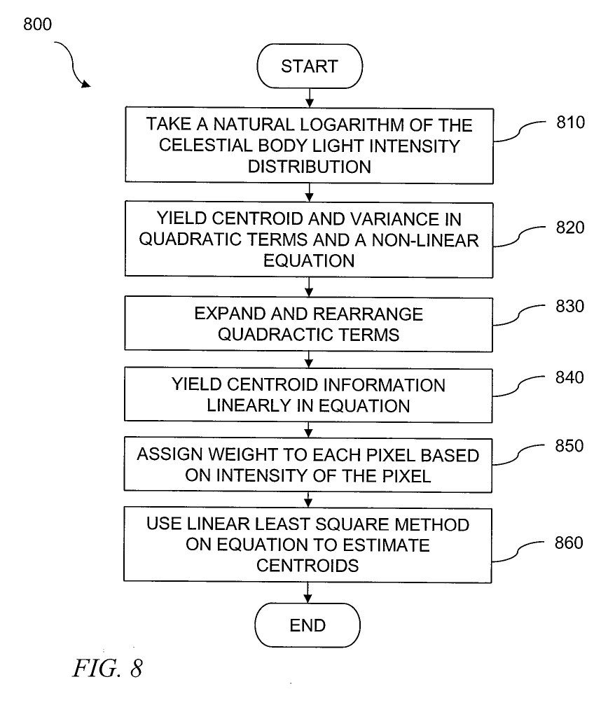

The Centroiding block 220 may receive a digital image from the Image Acquisition block 210 and compute the center of the energy deposited from each star's light before sending the centroided location data to a Star Identification block 250. Further details of enhancing centroiding determination are described below with reference to FIGS. 7 and 8.

The Star Identification block 250 may generally identify a star from comparing interstar angles, using updated calibration parameters from the Calibration block 240, star position data from the Centroiding block 220, searching the interstar angle data from a K-Vector building block 260, and looking up the right ascension and declination from a Star Catalog Processing block 270. The updated star catalog database from the Star Catalog Processing block 270 is received by a Star Catalog Block 252. The interstar angle data is received from the K-Vector building block 260 at a K-vector block 254.

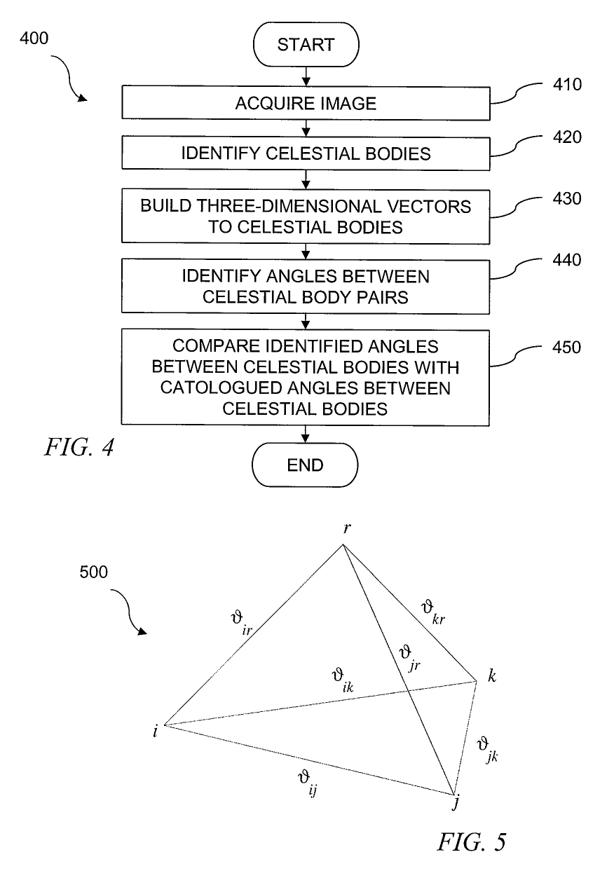

Example routines and/or software algorithms include, among others, routines for the K-vector database search and attitude estimation and the Pyramid algorithm, using the K-vector search of the database. Furthers details of one embodiment of the Pyramid algorithm are described below with reference to FIGS. 4 and 5.

The non-dimensional star identification may also be utilized in conjunction with algorithm specifically designed for uncalibrated cameras. Further details of an algorithm that may be utilized with uncalibrated cameras is described below with reference to FIG. 6.

In other embodiments, standard algorithms for computing centroids, camera calibration and conducting image acquisition may be employed. The preferred database is the K-vector which simplifies the search time for possible angle matches. Other example algorithms for the identification of stars are identified in following references: Ju, G. and Junkins, J. L., “Overview of Star Tracker Technology and its Trends in Research and Development,” Advances in the Astronautical Sciences, The John L. Junkins Astrodynamics Symposium, Vol. 115, 2003, pp. 461-478, AAS 03-285; Gottlieb, D. M., “Star Identification Techniques,” Spacecraft Attitude Determination and Control, 1978, pp. 259-266; Ketchum, E. A. and Tolson, R. H., “Onboard Star Identification Without A Priori Attitude Information,” Journal of Guidance, Control and Dynamics, Vol. 18, No. 2, March-April 1995, pp. 242-246; Kosik, J. C., “Star Pattern Identification Aboard an Inertially Stabilized Spacecraft,” Journal of Guidance, Control and Dynamics, Vol. 14, No. 2, March-April 1991, pp. 230-235; Gambardella, P., “Algorithms for Autonomous Star Identification,” Tech. Rep. TM-84789, NASA, 1980; Junkins, J. L., White, C. C., and Turner, J. D., “Star Pattern Recognition for Real Time Attitude Determination,” Journal of Astronautical Sciences, Vol. 25, No. 3, November 1977, pp. 251-270; Junkins, J. L. and Strikweerda, T. E., “Autonomous Attitude Estimation via Star Sensing and Pattern Recognition,” Proceedings of the Flight Mechanics and Estimation Theory Symposium, NASA-Goddard Space Flight Center, Greenbelt, MD, 1978, pp. 127-147; Strikewerda, T. E., Junkins, J. L., and Turner, J. D., “Real-Time Spacecraft Attitude Determination by Star Pattern Recognition: Further Results,” AIAA Paper 79-0254, January 1979; Sheela, B. V., Shekhar, C., Padmanabhan, P., and Chandrasekhar, M. G., “New Star Identification Technique for Attitude Control,” Journal of Guidance, Control and Dynamics, Vol. 14, No. 2, March-April 1991, pp. 477-480; Williams, K. E., Strikwerda, T. E., Fisher, H. L., Strohbehn, K., and Edwards, T. G., “Design Study: Parallel Architectures for Autonomous Star Pattern Identification and Tracking,” AAS Paper 93-102, Feb. 1993; Ball Aerospace Systems Group, Electro-Optics Cryogenics Division, Boulder, Colo., Specification Sheet for Ball Aerospace CT-601 Star Tracker; Cole, C. L., Fast Star Pattern Recognition Using Spherical Triangles, Master's thesis, State University of New York at Buffalo, Buffalo, N.Y., Jan. 2004; Mortari, D., “A Fast On-Board Autonomous Attitude Determination System Based on a New Star-ID Technique for a Wide FOV Star Tracker,” Advances in the Astronautical Sciences, Sixth Annual AIAA/AAS Space Flight Mechanics Meeting, Vol. 93, Pt. 2, 1996, pp. 893-903, AAS 96-158; Crassidis, J. L., Markley, F., Kyle, A., and Kull, K., “Attitude Determination Improvements for GOES,” Proceedings of the Flight Mechanics/Estimation Theory Symposium, NASA-Goddard Space Flight Center, Greenbelt, Md., May 1996; and U.S. Pat. Nos. 5,935,195; 4,658,361; 4,680,718; and 6,102,338.

Once celestial bodies are uniquely identified in the Star Identification Block 250, the logic architecture 200 (e.g., embedded in memory in the apparatus 100) may compute the offset between the pointing device or targeting device and the imaging system or digital imager in the Attitude Estimation block 280 to identify a single celestial body. The logic architecture 200 may search an on-board database and return the common name of the targeted celestial body (e.g., star name) with its associated constellation (if there is one).

In addition to the above referenced on-board database, an enhanced database (which may also be on-board) may provide a variety of information of interest to the user, including, but not limited to, common star names, relative star brightness, star constellation names (which may vary by region of the world), historically significant information, and scientifically significant information.

The star name, constellation, and other information, including the information described above may be displayed via the User Interface (UI) block 290 using a user interface screen embedded within the apparatus 100 or a screen in communication with the apparatus 100 via wired or wireless communications.

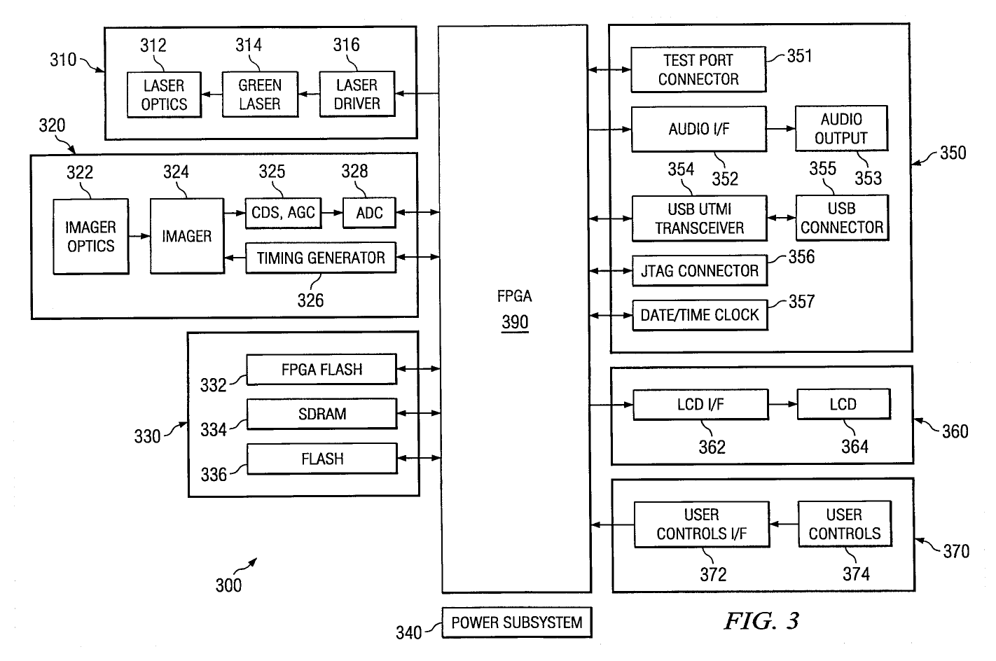

FIG. 3 depicts an electronic assembly 300, according to an embodiment of the invention. The electronic assembly 300, for example, may be utilized with the apparatus 100 (e.g., within the housing of the apparatus 100) and logic architecture 200 (e.g., embedded in memory, described in further details below). The electronic assembly 300 may include a variety of component parts, some of which are described below. For example, the electronic assembly 300 may include a central processor 390. The central processor 390 may be part of a wide variety of processing platforms (embedded and non-embedded) used to execute celestial body identification algorithms described herein, including, but not limited to, digital signal processors, microprocessors, microcontrollers, etc. In particular embodiments, certain platforms may be utilized because they are more efficient. For example, some efficient platforms support pipelined and/or parallelized implementation of the algorithms. Examples of these platforms include, but are not limited to, field programmable gate arrays and application specific integrated circuits. While several benefits are realized with efficient processing platforms, the most commonly recognized benefits include reduced execution time, reduced power consumption and reduced physical size. The preferred processor 390 is an FPGA as depicted in FIG. 3. The processor 390 may generally be in communication with groups of component parts—e.g., groups 310, 320, 330, 340, 35, 360, and 370.

Group 310 may generally represent a pointing device. In FIG. 3, group 310 includes subcomponents of laser optics 312, a green laser 314, and a laser driver 316. The laser driver 316 controls the voltage supplied to a laser diode and may receive temperature feedback from the laser diode. The green laser 314 may include an infrared laser diode, crystals, and a focusing lens. The laser diode emits light at, for example, a wavelength of 808 nm and may be focused by a lens through two crystal filters that reduce the wavelength to a desired wavelength of, for example, 532 nm. The laser optics 312 may include an infrared filter and collimating lens. The infrared filter reduces the amount of light at wavelengths higher than the desired 532 nm and the collimating lens reduces the diameter of the emitted beam. Although 808 nm and 532 nm wavelengths have been described in the above embodiment, other embodiments may utilize other wavelengths. For example, in other embodiments, the laser diode may emit a light at greater than or less than 808 nm and the one or more filters may alter the light wavelength (e.g., to wavelengths greater than or less than 532 nm).

Group 320 may generally represent an imaging device. In FIG. 3, group 320 includes one embodiment of the imaging device consisting of imager optics 322, a CCD imager 324, an Correlated Double Sampling (CDS)/ Automatic Gain Control (AGC) component 325, an analog to digital converter (ADC) 328, and a timing generator 326. The imager optics 322 focuses light onto the CCD imager 324 which produces electrons proportional to the amount of light intercepted at each pixel. The CDS portion of the CDS/AGC component 325 processes the video signal from the CCD by extracting the image information from the common mode level, distinguishing between the reference and signal voltage levels. The CDS portion of the CDS/AGC component 325 may improve the signal to noise ratio by eliminating reset noise and correlated noise components of the CCD video signal. The AGC portion of the CDS/AGC component 325 may amplify the output signal of the CDS in such a way to maximize the full dynamic range of the ADC 328. These components may exist separately or integrated into a single device.

Group 330 may generally represent memory, which, among other items, may store a portion of the logic of the logic architecture 200 of FIG. 2, recorded information (described in further detail below), and other information described above in FIG. 2 with reference to databases such as the on-board database and the enhanced database. In FIG. 3, group 330 includes FPGA Flash memory 332, SDPAM memory 334, and Flash memory 336. The memory stores data for initial operation of the device. The memory in some embodiments may be non-volatile and used during the computation sequence. Although specific types of memory have been shown in FIG. 3, it should be expressly understood that other types of memory may also be utilized.

Group 340 may generally represent a power subsystem, which may provide power to the various electronic components of the electronic assembly 300 and/or apparatus 200. Any of a variety of power sources may be utilized, including, but not limited to batteries.

Group 350 may generally represent other miscellaneous component parts. In FIG. 3, group 350 includes a test port connector 351, an audio interface (I/F) 352, an audio output 353, an external communication transceiver 354, an external communication connector 355, a JTAG connector 356, and a date/time clock component 357. In some embodiments, group 350 may provide audio feedback to a user (e.g. notification that a celestial body has or has not been successfully identified) or communication with an external device for the purpose of sending celestial body information. For example, as described above, in particular embodiments, an image may be captured and transmitted to another remote device for processing. One example given above is a mobile phone taking a picture of the night sky and communicating the digital image to a remote device for processing. Communications with external devices may also be utilized to update the on-board and/or enhancement database. In addition, the miscellaneous component parts may be used for testing and configuring aspects of the apparatus 100, logic architecture 200, and/or electronic assembly 300.

Groups 360 may generally represent a user display. In FIG. 3, the user display includes a digital display interface (I/F) 362 and a digital display 364. The digital display I/F 362 and digital display 364 may generally display information to a user, for example, information on the identification of celestial bodies. Additionally, in some embodiments Groups 350 and 360 may communicate with one another—e.g., through processor 390 to relay user inputs from group 370 back to a user 360 to view.

Group 370 may generally represent a user interface for receiving information from a user. In FIG. 3, group 370 generally includes a user controls interface (I/F) 372 and user controls 374. The user controls 374 in conjunction with the user controls interface (I/F) 372 may generally allow a user to manipulate a variety of parameters of the apparatus 100, logic architecture 200, and or electronic assembly 300. The user may actuate controls based on information received from the user display (Group 360).

The processor or FPGA 390, among other items, generally controls the imager (e.g., components of block 320), the laser or pointing device (e.g., components of block 310), the user interface screen (e.g., combination of components of block 350 and 360), and access to memory (e.g., components of block 330). The processor or FPGA may also control communications of the apparatus 100 with other devices. Such communications may include, but are not limited to, communications over a standard interface such as USB for interfacing with a web site or wireless communications. Using the communications and/or the varying forms of memory (e.g., including but not limited to SDRAM, Flash, FGPGA flash), information concerning the identification of a celestial body along with a date/time (e.g., using date/time clock) and any identified constellations may be recorded. In some embodiments, such information may be recorded by uploading the information to a web site, for example, using any of a variety of communication protocols.

FIG. 4 illustrates a method 400 of identifying celestial bodies using inter-celestial body angles, according to an embodiment of the invention. The method 400 has been simplified for purposes of illustration. Accordingly, as will be recognized by one of ordinary skill in the art, the method 400 may be altered according to the dynamics of the system in which it will be utilized. The method 400 illustrates some of the basics of Pyramid, a star identification algorithm.

Pyramid was developed to address problems associated with conventional celestial body identification algorithms, namely: slow data processing to find pattern matching in a large star catalog; lack of robustness to spurious image data (e.g., false stars induced by noisy imager, reflections, presence of non catalogued objects in the field of view, etc.); and reduced successful identification rate by methods that rely on star magnitude (brightness) to limit the number of computations required to identify a pattern due to the intrinsic difficulty of having a reliable estimation of the star magnitude. To address these issues Pyramid uses three dimensional vector observations instead of triangle patterns on the image plane. A vector observation is, in this context, the direction of a celestial body pairs in the camera reference frame. In certain embodiments, successful celestial body identification is accomplished by comparing vector observations of celestial body pairs in the camera frame of reference with the corresponding known celestial body vectors in an inertial frame of reference.

The method 400 begins by acquiring an image at step 410 (e.g., using the imager or digital imager 110 of FIG. 1) and identifying celestial bodies therein at step 420, for example, using a centroiding technique such as the centroiding technique described in greater details below with reference to FIGS. 7 and 8. Knowing optical calibration parameters of the camera used to capture the digital image (e.g., as may be determined by the calibration technique described with reference to FIG. 6), three dimensional vectors may be developed to celestial bodies at step 430, for example from a focal point. Then, the method 400 may proceed by identifying angles between the celestial bodies at step 440. Finally, at step 450, the identified angles between celestial bodies may be compared with catalogued angles between celestial bodies to determine a potential match—thereby identifying the celestial body.

Because a single celestial body pair is likely to have hundreds of candidate, multiple observations may be used to reduce the possible celestial body identification candidates to just one. For example, the angles between three or more celestial bodies may be utilized to identify a celestial body and/or celestial bodies. For example, in particular embodiments, three celestial bodies may initially be analyzed and then, a fourth reference celestial body may be tested. When four celestial bodies are analyzed, a pyramid is created, thereby increasing robustness against erroneous identification of celestial bodies. Further details of creating a pyramid are discussed below with reference to FIG. 5.

FIG. 5 schematically illustrates an identification of celestial bodies, according to an embodiment of the invention. Upon identification of three celestial bodies (e.g., i, j, and k), a unique triangle, ijk, may be identified by analyzing the indices associated with the celestial bodies, i, j, and k. The analysis may utilize a threshold to determine whether or not to accept the triangle. If the triangle is rejected, a new triangle may be analyzed. The triangle itself has three three-dimensional vectors (ik, jk, and ij).

Upon acceptance of a particular triangle, the triangle may be referenced against another celestial body, r, to form a pyramid. The pyramid increases robustness of identification, in part, because six three-dimensional vectors (ik, jk, ij, ir, jr, and kr ) are analyzed—an additional three vectors over analysis of a triangle alone. Although the technique has been illustrated with reference to two, three, and four celestial bodies, it should be expressly understood that more than four celestial bodies may be utilized in the analysis.

FIG. 6 illustrates a method 600 of calibrating an apparatus 100 for identifying celestial bodies, according to an embodiment of the invention. In particular embodiments, the intrinsic parameters of the imaging components of the apparatus 100 are key parameters for the correct operation of the celestial body identification algorithm. As an example, in particular embodiments, in order to estimate the vector observations in the frame of the camera (e.g., imaging device 110/lens 120), the focal length, the principal point offset, and the distortion parameters for the camera need to be known precisely. According to one embodiment of the invention, the estimation of such parameter may be determined using the digital camera itself and night sky images as described below in method 600.

The method 600 begins at step 610 by building vector observations using night sky images and nominal values of the intrinsic parameters. The method 600 proceeds to step 620 where angles between celestial bodies for each celestial body pair is calculated. Then, at step 630, one or more iterations of a non-linear Gaussian least square technique may occur to yield an optimal value of the intrinsic parameters that minimizes error at step 640. In particular embodiments, such a technique does not require any special apparatus and may be determined as part of the logic for celestial body identification, for a continuous, on board parameter estimation.

FIG. 7 illustrates a method 700 of estimating a local threshold for centroid determination, according to an embodiment of the invention. FIG. 8 illustrates a method 800 of estimating a centroid according to an embodiment of the invention. Centroiding is the process of determining the center of the celestial body intensity distribution on the focal plane. Using the centroid data and the calibration parameters, a line-of-sight unit vector to the celestial body may be determined which is then used to calculate angular separation between celestial bodies. In order to get an accurate angle between celestial bodies, in certain embodiments it is essential to estimate the centroid location of the celestial body with a high accuracy. Conventional centroid techniques such as center of mass (hyper-acuity), and derivative searching are sensitive to the background noise in the image and require a very good knowledge of the threshold used for detecting the presence of a celestial body. In terrestrial applications the sky background is variable and depends on the night-sky viewing conditions. In addition, the background could vary locally in the image owing to ambient lighting conditions and proximity to surface objects such as buildings, trees etc. Accordingly, the method 700 estimates a local threshold for centroid determination.

The method 700 begins at step 710 by acquiring an imaging, for example, using the imager or digital imager 110 of FIG. 1. Then, at step 720, pixels in the image having intensities above a global threshold are identified. The global threshold in particular embodiments may be determined in prior night sky testings. This identification yields, at step 730, a mask around each celestial body.

At step 740, the underlying background is identified. In particular embodiments, the underlying background may be determined by taking a 3-4 pixel wide border around each mask of the celestial body. In other embodiments, the underlying background may be taken from more than or fewer than 3-4 pixels around each mask. In yet other embodiments, the underlying background may be all or portions of the image not part of a mask for a celestial body.

At step 750, the background surface is determined. The underlying background in particular embodiments is assumed to have a bi-quadratic profile. Therefore, a 2D polynomial with a degree two is used as the basis function. Higher orders of polynomials in particular embodiments may also be used if the background contains higher order frequencies. A sensitivity matrix is obtained using the data points and the polynomial parameters defining the surface are estimated using a linear least squares technique.

At step 760, once the background surface is determined at step 760, the background surface may be subtracted from the actual pixel intensity values in each celestial body mask to give a noise-mitigated and background corrected celestial body light intensity distribution for each mask.

The celestial body intensity distribution on a focal plane can be represented approximately by a bi-variate Gaussian distribution. The parameters defining the distribution are the centroid location, the variance—e.g., the spread and the amplitude of the Gaussian.

The method 800 of estimating a centroid of FIG. 8 may begin at step 810 by taking a natural logarithm of the function for the bi-variate Gaussian distribution. This yields, at step 820, the centroid and the variance in quadratic terms along with a non-linear equation. A non-linear least squares technique may be used to solve the non-linear equation and estimate the parameters iteratively. However, this requires an initial guess to the solution and convergence is not always assured.

Accordingly, in particular embodiments, realizing that the centroid location is the most important parameter, it may not be necessary to estimate all the parameters defining the 2D Gaussian explicitly. Therefore, at step 830, quadratic terms are expanded and rearranged, yielding, at step 840, the centroid information linearly in the equation.

In particular embodiments, pixels located farther away from the center, although containing a small fraction of the celestial body energy, contribute the most to the error in the centroid location. Therefore, at step 850, a weighting scheme may be used to weight the celestial body light distribution. In step 850, a function based on the intensity of the pixel itself, may be used to assign weight to each pixel in the least squares estimation. Then, at step 860, a linear least square method may be utilized to estimate centroids.

In particular embodiments, using method 600 of FIG. 6 and method 700 of FIG. 7 may result in:
a centroid estimation that is more accurate than other approaches such as center of mass, derivative search etc,
a reduction in errors in centroids of less than 1/20 th of a pixel in night sky experiments,
a robust technique for varying lighting conditions and noise levels, and
a technique that is faster than performing a non-linear Gaussian least squares to estimate the 2D Gaussian fit.

The methods described with reference to FIGS. 4-8 may all be integrated into a single architecture, for example, the logic architecture of FIG. 2.

Utilizing embodiments, described above with reference to FIGS. 1-8, a user may be able to determine the identity of a targeted celestial body from anywhere that the user has a view of the celestial body. The effect of this identification may allow many casual observers of celestial bodies to become familiar with their common names and associated constellations.

It should be expressly understood that although specific components and steps have been described with reference to certain embodiments, other embodiments may utilize more, fewer or different components and/or steps.

Additionally, numerous other changes, substitutions, variations, alterations, and modifications may be ascertained to one skilled in the art and it is intended that the present invention encompass all such changes, substitutions, variations, alterations, and modifications as falling within the scope of the appended claims.

What is claimed is:

1. A system for automatic identification of celestial bodies, the system comprising:
an imager operable to accept incoming light from celestial bodies and produce a digital image; and
logic encoded in media such that when executed is operable to:
identify centroids of the celestial bodies within the digital image, and
identify the celestial bodies by comparing angles derived from the centroids with catalogued values.

2. The system of claim 1, wherein
the imager and the logic encoded in media are contained in a first enclosure, and
the first enclosure is sized to be held in a hand of a user or in a telescope mount.

3. The system of claim 2, further comprising:
a pointing device operable to facilitate an alignment of the imager with the celestial bodies.

4. The system of claim 3, wherein the pointing device is a laser.

5. The system of claim 4, wherein the pointing device is a green laser.

6. The system of claim 3, wherein the pointing device is a viewer or interface screen through which a user may view celestial bodies.

7. The system of claim 2, further comprising:
a user interface screen operable to display an identity of identified celestial bodies.

8. The system of claim 7, wherein the user interface screen is contained within the first enclosure.

9. The system of claim 7, wherein the user interface screen is contained within a second enclosure separate from the first enclosure.

10. The system of claim 2, further comprising:
an audio output operable to communicate an identity of identified celestial bodies.

11. The system of claim 2, wherein the first enclosure is self-powered.

12. The system of claim 2, further comprising:
a communication component operable to communicate with other systems.

13. The system of claim 12, wherein the communication component is operable to receive updates to the logic encoded in media.

14. The system of claim 12, wherein the communication component is operable to communicate an identity of identified celestial bodies to the other systems.

15. The system of claim 12, wherein the communication component wirelessly communicates with the other systems.

16. The system of claim 1, further comprising:
a communication component operable to communicate the digital image to the logic encoded in media, wherein:
the imager and the communication component are contained in a first enclosure, and
at least a portion of the logic encoded in media is contained in a second enclosure remote from the first enclosure.

17. The system of claim 16, wherein the communication component wirelessly communicates the digital image to the at least a portion of the logic encoded in media in the second enclosure.

18. The system of claim 17, wherein the first enclosure is a mobile phone.

19. The system of claim 17, wherein the second enclosure is a computer.

20. A method for automatically identifying celestial bodies, the method comprising:
acquiring a digital image with celestial bodies;
identifying centroids of the celestial bodies within the digital image;
generating calibration parameters based on the acquired digital image;
building three-dimensional line-of-sight vectors to the celestial bodies using the centroids and the calibration parameters;
calculating inter-celestial body angles associated with the three-dimensional vectors; and
identifying the celestial bodies by comparing the calculated angles with catalogued angles between celestial bodies.

21. The method of claim 20, further comprising:
identifying at least four centroids for at least four celestial bodies;
building at least four three-dimensional vectors between the at least four centroids using the calibration parameters, the at least four three-dimensional vectors forming a pyramid.

22. The method of claim 20, wherein identifying centroids of celestial bodies further comprises:
identifying pixels in the digital image above a global threshold to yield a mask around each celestial body;
identifying the underlying background of the digital image;
determining a surface of the underlying background; and
subtracting the surface of the underlying background from each of the respective masks around each celestial body to yield a celestial body light intensity distribution.

23. The method of claim 22, wherein identifying centroids of celestial bodies further comprises:
taking a natural logarithm of the celestial body light intensity distribution to yield centroid information in quadratic terms;
expanding and rearranging the quadratic terms to yield centroid information linearly in an equation; and
using a linear least square method to estimate the location of the centroids.

24. The method of claim 20, wherein generating calibration parameters further comprises:
building nominal three-dimensional line-of-sight vectors to the celestial bodies using the centroids and a nominal value for intrinsic parameters;
calculating departures from the true inter-celestial body angles associated with the nominal three-dimensional vectors; and
iteratively using a non-linear Gaussian least square technique on the departures to yield calibration parameters that minimize error.

25. The method of claim 20, further comprising:
communicating the identification of the celestial bodies by audio communication or visual communication.

26. The method of claim 20, further comprising:
associating enhancement information with the identified celestial body; and communicating the enhancement information to a user.

27. The method of claim 20, wherein identifying centroids, generating calibration parameters, calculating angles, and identifying celestial bodies are carried out in an embedded processing architecture.

28. The method of claim 27, wherein the embedded processing architecture includes a field programmable gate array (FPGA).

29. The method of claim 20, wherein acquiring the digital image is carried out by a first device and identifying centroids, generating calibration parameters, calculating angles, and identifying celestial bodies are carried out on a second device.

30. Logic encoded in a computer readable media such that when executed is operable to:
receive a digital image with celestial bodies;
identify centroids of the celestial bodies within the digital image;
generate calibration parameters based on the acquired digital image;
build three-dimensional line-of-sight vectors to the celestial bodies using the centroids and the calibration parameters;
calculate angles associated with the three-dimensional vectors; and
identify the celestial bodies by comparing the calculated angles with catalogued angles between celestial bodies.

31. The logic of claim 30, wherein the logic in identifying centroids of celestial bodies is operable to:
identify pixels in the digital image above a global threshold to yield a mask around each celestial body;
identify the underlying background of the night digital image;
determine a surface of the underlying background; and
subtract the surface of the underlying background from each of the respective masks around each celestial body to yield a celestial body light intensity distribution.

32. The logic of claim 31, wherein the logic in identifying centroids of celestial bodies is operable to:
take a natural algorithm of the celestial body light intensity distribution to yield centroid information in quadratic terms;
expand and rearrange the quadratic terms to yield centroid information linearly in an equation; and
use a linear least square method to estimate the location of the centroids.

33. The logic of claim 30, wherein the logic is further operable to:
communicate the identification of the celestial bodies by audio communication or visual communication.

34. The logic of claim 30, wherein the logic in generating calibration parameters is operable to:
build nominal three-dimensional line-of-sight vectors to the celestial bodies using centroids and a nominal value for intrinsic parameters;
calculate departures from the inter-celestial body angles associated with the nominal three-dimensional vectors; and
iteratively use a non-linear Gaussian least square technique on the departures to yield calibration parameters that minimize error.
